(19) United States
(12) Patent Application Publication
(10) Pub. No.: US 2008/0072074 A1
(43) Pub. Date: Mar. 20, 2008

(54) Information-protection device, information-protection system, information-protection method, and program-storage medium storing information protection program

(75) Inventor: Takashi Miyamoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,685

(22) Filed: Aug. 27, 2007

(30) Foreign Application Priority Data
Sep. 19, 2006 (JP) 2006-252502

(51) Int. Cl. G06F 12/14; G06F 11/30

(52) U.S. Cl. 713/193

(57) ABSTRACT

Input data is decoded by a decoder. Decoded data that cannot be processed is stored in an unknown-data storage. The unknown data is encoded by an encoder at a time of user's check to be returned to clear data. The input checker shows the input data that has been returned to the clear data to the user for obtaining permission for use. When data is output, an output checker shows the output data to the user for obtaining permission for output, and an instruction of clear output or encoded output is received from the user. When data is stored into a hard disc, the data is encoded. As a result, information in a computer is protected.

### BACKGROUND OF THE INVENTION

1. Field of the Invention

The present invention relates to a device for protecting information, and more particularly to a device for protecting information that is held in a computer.

2. Description of the Related Art

Problems upon protecting information held in a computer have been focused on. In order to deal with information falsification, information leakage, and the like caused by a computer virus and a spyware, detection programs for the computer virus and the spyware are developed. The detection program checks all the files in the computer through file matching with use of check patterns accumulated in a prepared pattern file that is created by accumulating a large number of check patterns based on characteristics of the computer virus and the spyware New computer virus and spyware are prepared day after day and spread in no time via the Internet or the like. Thus, it is necessary to develop check patterns corresponding to new computer virus and the spyware, which constantly requires pattern file update operations for adding the check patterns to the pattern file. Also, this measurement principally follows the outbreak of the computer virus and the spyware, and therefore there is a risk of virus infection until the pattern file is updated.

On the other hand, a method of automatically encoding/decoding information output to/input from an external storage medium is also devised (for example, Japanese Unexamined Patent Application Publication No. 1-227272). This method is devised so that even when information stored in the external storage medium is leaked, this information is not decoded without knowing a decryption key and the actual damage is thus avoided from the leakage. At the same time the computer user does not need to perform a specific process for this measurement, and encoding/decoding is automatically effected when a usual output/input process is merely performed. It should be noted that the information taken into the computer from a source other than the external storage medium that performs this measurement may include a computer virus or a spyware. Also, even the information read from the external storage medium that performs this measurement is in the clear in the computer, and there is still a risk of leakage of the clear data caused by the spyware.

That is, the conventional technology is to check the invading computer virus and spyware or to invalidate information leaked from a particular external storage medium. Therefore, the computer virus and the spyware invading the computer are capable of operating the computer until the computer virus and the spyware are checked, and the output of the information to a destination other than the particular external storage medium is not protected.

### SUMMARY OF THE INVENTION

Accordingly, it is an object of the present invention to protect information held in a computer. In particular, it is an object of the present invention to reduce the possibility of suffering damage caused by a computer virus or a spyware while data which may include a computer virus or a spyware is not allowed to operate a computer until the user's check, or to reduce the possibility of suffering damage caused by the leak of information while the information held in the computer is not allowed to be output in the clear to the outside without a permission of the user.

One aspect of the present invention provides an information-protection device which protects information held in a computer. The information-protection device is connected to the computer. The computer executes an existing function prescribed in an operating system or an application program. The information-protection device includes: a decoder which decodes data which is input for the existing function; an unknown-data storage which stores data that cannot be processed in the existing function, as unknown data; an encoder which encodes the unknown data; an input checker which displays a part of the encoded unknown data on a display device, and in response to a first instruction from a user, causes the computer to execute the existing function with the encoded unknown data as input data; and an output checker which displays a part of output data from the existing function on the display device, and in response to a second instruction from the user, encodes the output data and outputs the encoded output data.

Another aspect of the present invention provides an information-protection system which includes the computer and the information-protection device mentioned above.

Another aspect of the present invention provides an information-protection method for protecting information held in a computer. The computer executes an existing function prescribed in an operating system or an application program. The information-protection method includes: a step in which data which is input for the existing function is decoded; an step in which data that cannot be processed in the existing function is stored as unknown data; an step in which the unknown data is encoded; an step in which a part of the encoded unknown data is displayed on a display device, and in response to a first instruction from a user, the computer is caused to execute the existing function with the encoded unknown data as input data; and a step in which a part of output data from the existing function is displayed on the display device, and in response to a second instruction from the user, the output data is encoded and is output.

Still another aspect of the present invention provides a program storage medium which is readable by a computer. The program-storage medium stores a program of instructions for the computer to execute method steps of the information-protection method mentioned above.

According to the present invention, the data which is input to the computer for the first time from a communication device or a storage device is firstly decoded and is put into a state where the data cannot operate the computer. It is not until the user checks the data that the data is encoded to be returned to clear data. Even when the data includes a computer virus or a spyware, the possibility of unexpectedly operating the computer is substantially reduced. In addition, the data which is output to the outside from the computer is encoded without a permission of the user, and thus the possibility of information leakage is substantially reduced.

### BRIEF DESCRIPTION OF THE DRAWINGS

FIG. 1 shows a system configuration of an information-protection device according to a first embodiment of the present invention;

FIG. 2 is a flowchart for the information-protection device according to the first embodiment of the present invention;

FIG. 3 is a flowchart of an encoding process of an output checker in the information-protection device according to the first embodiment of the present invention;

FIG. 4 is a process flowchart of an encoder in the information-protection device according to the first embodiment of the present invention;

FIG. 5 is a flowchart of a decoding process in the information-protection device according to the first embodiment of the present invention;

FIG. 6 is a flowchart of a user permission check process for unknown data in the information-protection device according to the first embodiment of the present invention;

FIG. 7 is a flowchart for the information-protection device according to a second embodiment of the present invention; and

FIG. 8 shows an example of a computer environment.

### DESCRIPTION OF THE PREFERRED EMBODIMENTS

Hereinafter, embodiments of the present invention will be described with reference to drawings.

### First Embodiment

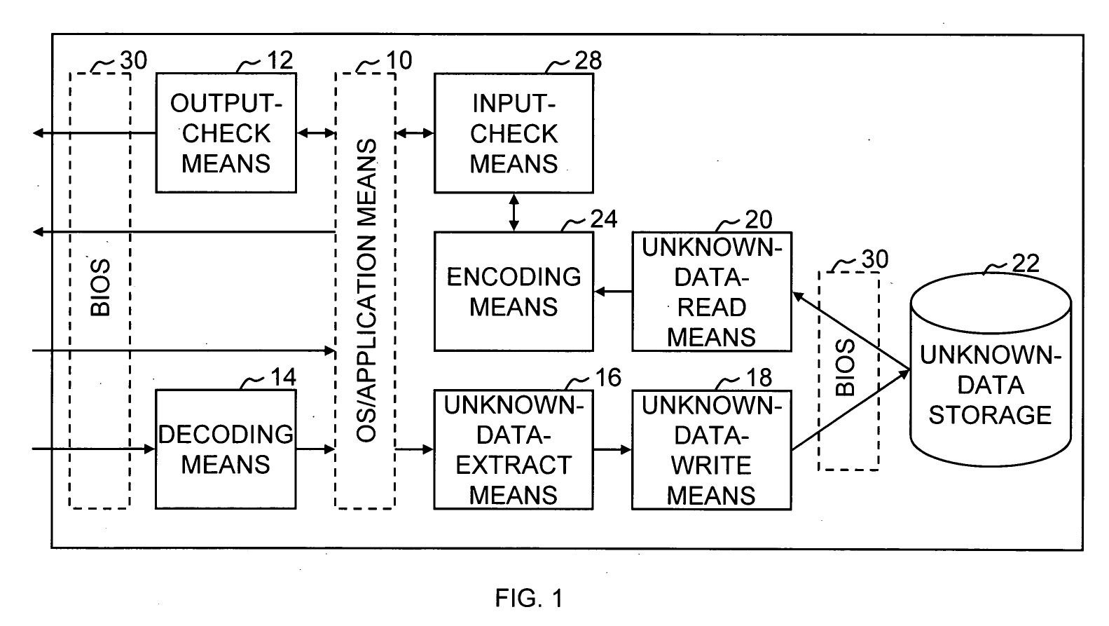

FIG. 1 shows a system configuration of an information-protection device according to a first embodiment of the present invention. The information-protection device according to this embodiment includes a decoder 14 for interrupting between a process of existing function prescribed in a BIOS (Basic Input/output System) 30 and a process of existing function prescribed in an OS (Operating System) or an application program (hereinafter a processor of the process is referred to as OS/application processor 10) and for decoding data that is input to a computer, an unknown-data extractor 16 for extracting data that cannot be normally processed by the computer, an unknown-data storage 22 for storing the extracted unknown data, an unknown-data writer 18 for writing the unknown data into the unknown-data storage 22, an unknown-data reader 20 for reading the unknown data from the unknown-data storage 22, an encoder 24 for encoding the unknown data, an input checker 28 for asking a user for a permission of using the unknown data, and an output checker 12 for asking the user for a permission of outputting data from the computer and for encoding the output data when necessary.

The decoder 14 is performs a decoding process corresponding to a predefined encoding process. When input data from a source other than a human interface device such as a key board or a mouse that is operated by the user is input from the BIOS 30, the decoder 14 effects interruption and decodes the input data to create data that has been decoded (hereinafter, referred to as “decoded data”). Furthermore, the input data is replaced with the decoded data and thereafter the interruption is canceled.

The unknown-data extractor 16 effects interruption when it detects that the target data of the OS/application processor 10 cannot be processed. The unknown-data extractor 16 takes the data away from the OS/application processor 10, transfers the data to the unknown-data writer 18, and then cancels the interruption.

The unknown-data writer 18 writes the data received from the unknown-data extractor 16 into the unknown-data storage 22 via the BIOS 30.

The unknown-data reader 20 transfers the data that is read from the unknown-data storage 22 via the BIOS 30, to the encoder 24.

The encoder 24 encodes the data received from the unknown-data reader 20 to be returned to the clear data and transfers the clear data to the input checker 28.

The input checker 28 effects interruption when the clear data is received from the encoder 24 and asks the user for a permission of using the clear data. When the user permits the use of the clear data, the input checker 28 sets the clear data to be processed by the OS/application processor 10, cancels the interruption, and then allows the process of the OS/application processor 10 to be continued. When the user does not permit the use of the clear data, the input checker 28 discards the clear data and then cancels the interruption.

When the output checker 12 detects that the OS/application processor 10 attempts to output the data to a destination other than a human interface device such as a display device or a loudspeaker, the output checker 12 effects interruption and asks the user for a permission of outputting this data and an instruction of outputting clear data (hereinafter, referred to as “clear output”) or outputting encoded data (hereinafter, referred to as “encoded output”). When the user permits output of the data and instructs the encoded output, the output checker 12 encodes this data, and replaces the output data with data that has been encoded (hereinafter, referred to as “encoded data”) and then cancels the interruption, thereby outputting the data to the BIOS 30. When the user permits output of the data and instructs the clear output, the output checker 12 cancels the interruption and outputs the data to the BIOS 30. When the user does not permit output of the data, the output process is terminated.

An encryption algorithm and an encryption key used by the encoder 24 are completely the same to as those used by the output checker 12. A relation between a set of the encryption algorithm and the encryption key used by the encoder 24 and a set of the decryption algorithm and the decryption key used by the decoder 14 is expected to meet the following two conditions. According to the first condition, in a case where this encryption key is used to encode clear data on the basis of this encryption algorithm, when the encoded data is decoded with use of this decryption key on the basis of this decryption algorithm, the clear data is obtained. According to the second condition, in a case where this decryption key is used to decode clear data on the basis of this decryption algorithm, when the decoded data is encoded with use of this encryption key on the basis of this encryption algorithm, the clear data is obtained.

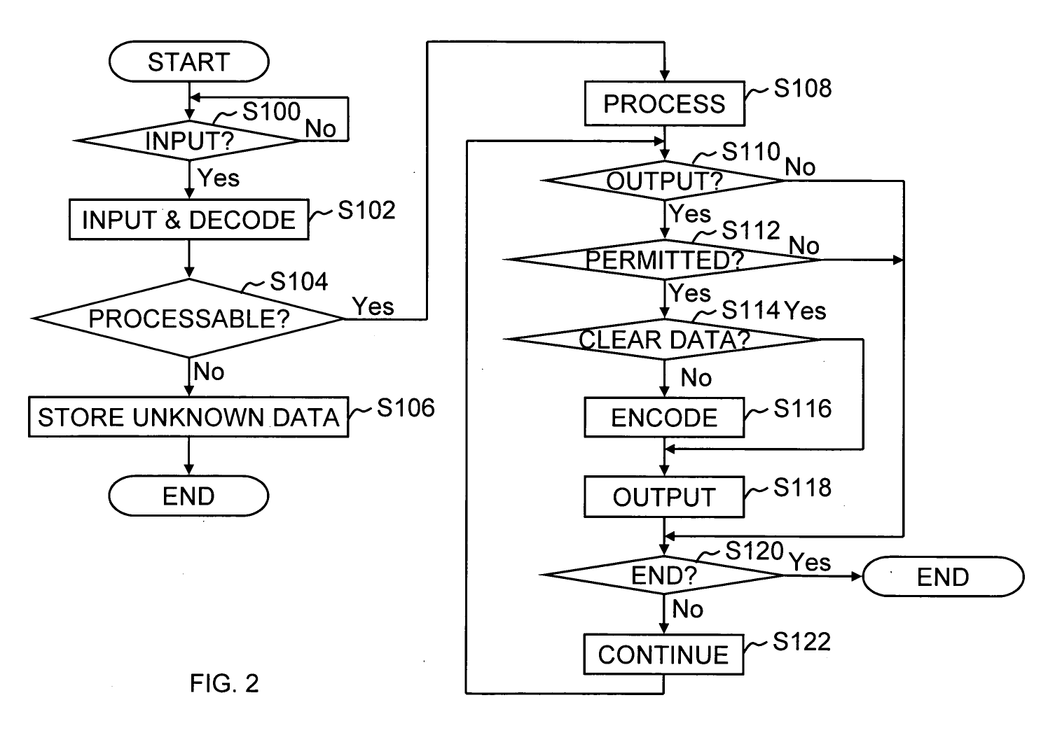

FIG. 2 is a flowchart for the information-protection device according to the first embodiment of the present invention. A flow of a process of the information-protection device according to this embodiment will be described with reference to Steps S100 to S118 of FIG. 2 in sequence.

(Step S100) When data input is to be performed, the OS/application processor 10 issues an input command. The input checker 28 monitors the input command issued by the OS/application processor 10.

(Step S102) When the input checker 28 detects the input command issued by the OS/application processor 10 (Step S100: Yes), the input checker 28 effects interruption, decodes the input data from the BIOS 30 with use of the decoder 14, replaces the input data with the decoded data, and cancels the interruption.

(Step S104) The OS/application processor 10 inputs the decoded data and attempts to process the data. At this time, when the data that is input in Step S102 is clear data, the decoded data is meaningless data, and the process of the OS/application processor 10 is not normally started. For this reason, an error signal is issued by the OS/application processor 10. The unknown-data extractor 16 monitors the error signal. On the other hand, when the data that is input in Step S102 is the encoded data, this encoded data is returned to the clear data due to the decoding in Step S102, and the data can be normally processed by the OS/application processor 10.

(Step S106) when the unknown-data extractor 16 detects the error signal (Step S104: No), the unknown-data extractor 16 effects interruption, takes the targeted decoded data away from the OS/application processor 10, and transfers the data to the unknown-data writer 18. The unknown-data writer 18 writes the decoded data into the unknown-data storage 22 and cancels the interruption.

(Step S108) When the unknown-data extractor 16 does not detect the error signal (Step S104: Yes), the OS/application processor 10 continues its process with the clear data as a target.

(Step S110) When it is necessary to output data during a course of the process of the OS/application processor 10, the computer issues an output command. The output checker 12 monitors the output command issued by the OS/application processor 10.

(Step S112) When the output checker 12 detects the output command issued by the OS/application processor 10 (Step S110: Yes), the output checker 12 effects interruption, shows the clear data to be output to the user, and asks the user as to whether or not the data is allowed to be output.

(Step S114) When the user permits the output of the clear data (Step S112: Yes), the output checker 12 asks the user as to whether the clear data should be output in the clear or the data should be encoded.

(Step S116) When the user instructs the encoded output (Step S114: No), the output checker 12 encodes the clear data. The output checker 12 replaces the clear data that is the target data of the output command with the encoded data and then cancels the interruption.

(Step S118) The BIOS 30 outputs the output data.

In a case where the data is structured, the method of data encoding or decoding varies depending on whether or not the information-protection device is informed of the data structure.

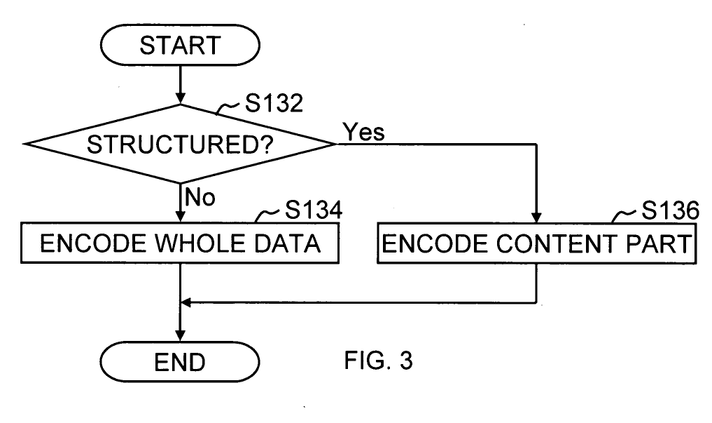

FIG. 3 is a flowchart of an encoding process of the output checker 12 in the information-protection device according to the first embodiment of the present invention. A flow of the encoding process of the output checker 12 will be described with reference to Steps S132 to S136 in FIG. 3 in sequence.

(Step S132) The output checker 12 checks whether or not the target data of the encoding has a known structure. For the data having the known structure, a content part in the structured data is defined in advance. It is arbitrary to define which part in the structured data is the content part. For example, in a case of a program data file, a program main part is regarded as the content part and a file name is not regarded as the content part. Also, for example, in a case of message data such as a mail, a message body is regarded as the content part and a message header is not regarded as the content part. In other words, a part of data that is a clue to find out a feature of the data and is relatively safe is not regarded as the content part.

(Step S134) When the target data does not have a known structure (Step S132: No), the output checker 12 encodes the entirety of the target data.

(Step S136) When the target data has a known structure (Step S132: Yes), the output checker 12 encodes only a content part of the target data and does not encode other part of the target data. The structure that is not included in the content part is also allowed to exist after the encoding.

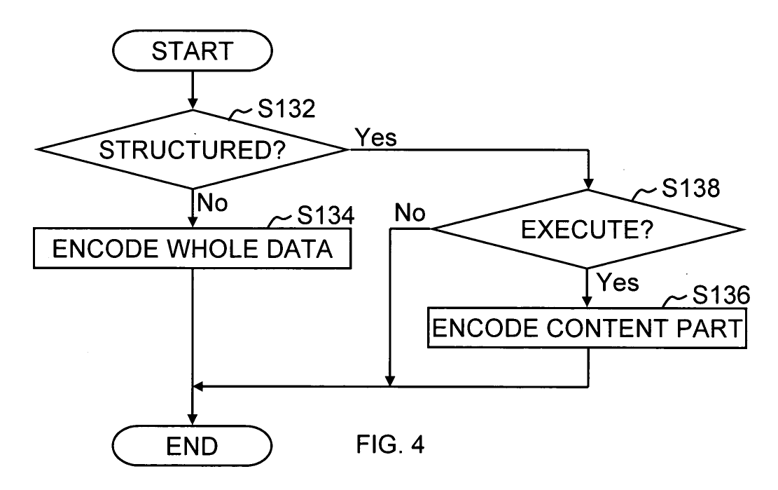

FIG. 4 is a process flowchart of an encoder 24 in the information-protection device according to the first embodiment of the present invention. The flow of the process of the encoder 24 is slightly different from the encoding process of the output checker 12. The process contents from Step S132 to Step S136 in FIG. 4 are the same as those in FIG. 3. In FIG. 4, a process in Step S138 is performed before Step S136.

(Step S138) When the target data has a known structure (Step S132: Yes), the encoder 24 does not encode the target data but transfers the target data to the input checker 28. The input checker 28 shows a part of the target data which is other than the content part to the user, and asks the user as to whether or not the encoding may be executed. When the encoding is unnecessary, the process is ended as it is.

(Step S136) When the encoding is to be executed (Step S138: Yes), among the target data, the encoder 24 does not encode data other than the content part but encodes only the content part and then transfers the target data to the input checker 28.

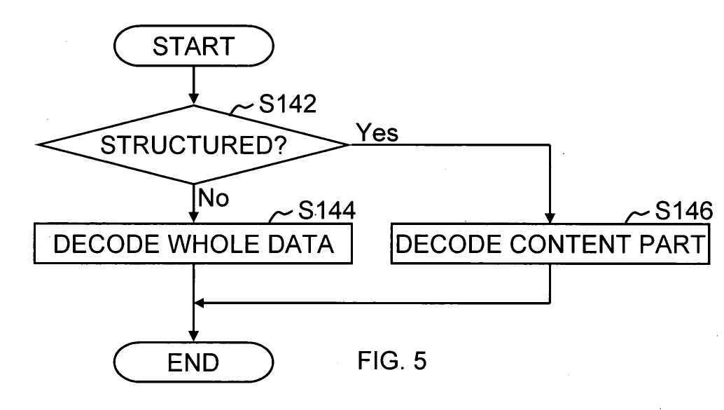

FIG. 5 is a flowchart of a decoding process in the information-protection device according to the first embodiment of the present invention. A flow of the decoding process according to this embodiment will be described with reference to Steps S142 to S146 in FIG. 5 in sequence.

(Step S142) The decoder 14 checks whether or not the target data of the decoding has a known structure.

(Step S144) When the target data of the decoding does not have a known structure (Step S142: No), the decoder 14 decodes the entirety of the target data.

(Step S146) When the target data of the decoding has a known structure (Step S142: Yes), among the target data, the decoder 14 decodes only the content part and does not decode other part. The structure that is not included in the content part is also allowed to exist after the decoding.

The use or non-use of the unknown data stored in the unknown-data storage 22 is determined by the user when the user operates the computer.

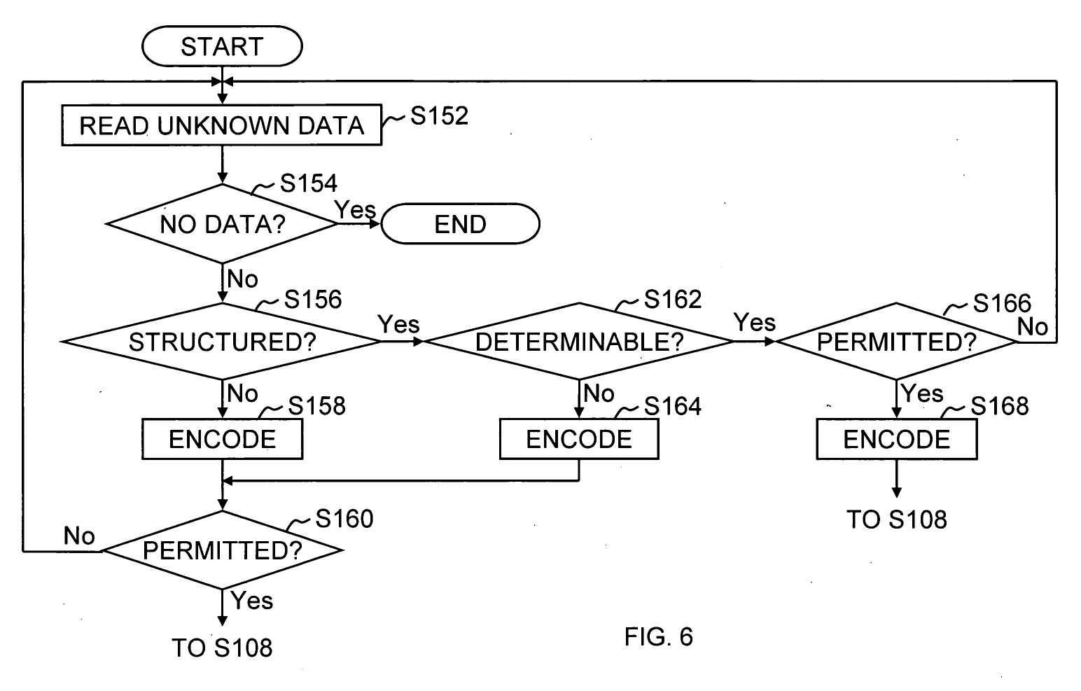

FIG. 6 is a flowchart of user permission check process for the unknown data in the information-protection device according to the first embodiment of the present invention. A flow of the user permission check process for the unknown data according to this embodiment will be described with reference to Steps S152 to Step S168 in FIG. 6 in sequence.

(Step S152) The unknown-data reader 20 reads one of unknown data from the unknown-data storage 22.

(Step S154) When there is no unknown data left in the unknown-data storage 22 (Step S154: Yes), the process is ended.

(Step S156) When unknown data is read from the unknown-data storage 22 (Step S154: No), the encoder 24 checks as to whether or not the unknown data has a known structure.

(Step S158) In a case where the unknown data does not have a known structure (Step S156: No), the encoder 24 encodes the entirety of the unknown data and transfers the encoded unknown data to the input checker 28.

(Step S160) The input checker 28 shows the encoded unknown data to the user to ask the user as to whether or not this unknown data may be used. When the user instructs that this unknown data is not used (Step S160: No), this unknown data is discarded, and the process is returned to Step S152. It should be noted that when the user will have a second thought at a later time, such a process of returning this unknown data to the unknown-data storage 22 may be performed. When the user instructs that this unknown data may be used (Step S160: Yes), the input checker 28 sets the unknown data to be executed by the OS/application processor 10 and cancels the interruption. The process after this is shifted to Step S108 in FIG. 2.

(Step S162) In a case where the unknown data has a known structure (Step S156: Yes), the encoder 24 does not encode the unknown data and transfers the unknown data to the input checker 28 as it is. The input checker 28 shows a part of the unknown data that is not encoded to the user and asks the user as to whether or not the user can determine the use or non-use of the data on the basis of the clear data part such as the file name and the title.

(Step S164) When a response from the user indicates that the user cannot determine the use or non-use of the data on the basis of the unknown data that is not encoded (Step S162: No), the input checker 28 requests the encoder 24 to encode the unknown data. The encoder 24 encodes the unknown data and transfers the encoded unknown data to the input checker 28. The process after this is shifted to Step S160.

(Step S166) When a response from the user indicates that the user can determine the use or non-use of the data on the basis of the unknown data that is not encoded (Step S162: Yes), the input checker 28 asks the user as to whether or not this unknown data may be used. When the user instructs that this unknown data may not be used (Step S166: No), the input checker 28 informs the encoder 24 that the encoding is unnecessary. Then, this unknown data is discarded, and the process is returned to Step S152. It should be noted that when the user will have a second thought at a later time, a process of returning this unknown data to the unknown-data storage 22 may be performed.

(Step S168) When the user instructs that this unknown data may be used (Step S166: Yes), the input checker 28 requests the encoder 24 to encode the unknown data. The input checker 28 receives the encoded unknown data from the encoder 24. The input checker 28 sets the encoded unknown data to be executed by the OS/application processor 10 and cancels the interruption. The process after this is shifted to Step S108 in FIG. 2.

With the above-mentioned processes, the data in the computer is protected in the following manner.

The data which is input to this computer is always decoded. In a case where the input data is encoded by this computer beforehand, the data is returned to the clear data through the decoding, and therefore the data can be processed by the OS/application processor 10 as usual. On the other hand, in a case where the input data is not encoded beforehand by this computer, the decoded data is unknown to the OS/application processor 10, and the input data cannot be processed by the OS/application processor 10. Therefore, even if the input data includes a computer virus or a spyware, the decoded computer virus or the decoded spyware cannot operate the computer. The input data that cannot be processed by the OS/application processor 10 is decoded and temporarily stored in the unknown-data storage 22 as unknown data. As long as being decoded, even when the input data includes the computer virus or the spyware, the computer is safe. It should be noted that when the information-protection device is informed of the structure of the input data, a part of data that is a clue to find out a feature of the data and is relatively safe, such as the file name or the message title, is not decoded and is kept in the clear.

The use or non-use of the unknown data is determined by the user. When the user determines the use or non-use of the unknown data, the unknown data is encoded, that is, the data is returned to the clear data to be shown to the user. However, when the structure of the input data is known, the encoding is not performed and the file name, the message title, or the like, which is in the clear from the beginning is firstly shown to the user, and only if the user cannot determine on the basis of the shown name or title, the decoded data is encoded and returned to the clear data. In this way, the data is not returned to the clear data straight away and a phase of determination based on the file name, the message title, or the like is inserted, whereby the safety is further enhanced.

The input data whose use is permitted by the user is processed by the OS/application processor 10 as usual in the clear. On the other hand, the input data whose use is not permitted by the user is discarded.

With respect to the data that is output from the computer to the outside as well, the user determines whether or not the data may be output. In a case where the OS/application processor 10 attempts to output some data, the output checker 12 shows the output data to the user and asks the user as to whether or not the output may be performed. At that time, the user also instructs that the data should be output in the clear or the data should be encoded. This is because the data is encoded when the data is stored in an external storage device.

As described above, according to the present invention, the input data unknown to the computer, that is, the data which may include a computer virus or a spyware is in a state where the data cannot operate the computer until the user performs the checking, and therefore the possibility of suffering damage caused by the computer virus or the spyware can be reduced. Also, according to the present invention, the information in the computer is not output in the clear to the outside without the permission of the user, and therefore it is possible to reduce the possibility of suffering damage caused by the leak of information.

### Second Embodiment

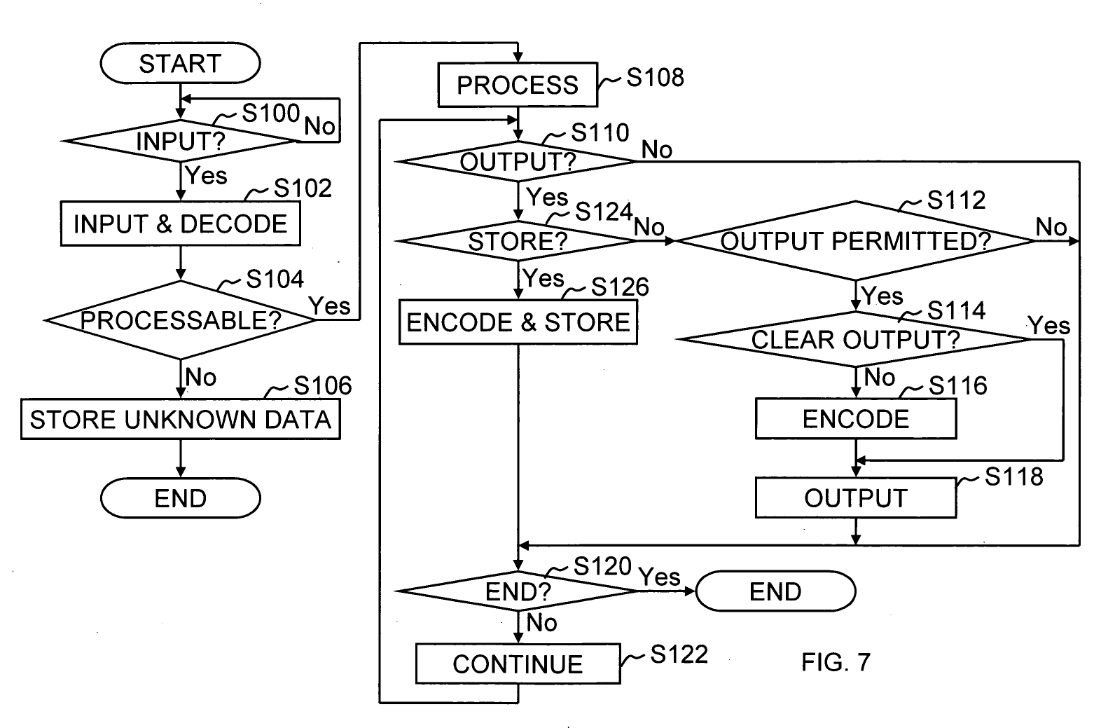

FIG. 7 is a flowchart of the information-protection device according to a second embodiment of the present invention. In contrast to the flowchart of FIG. 2 which shows the flow of the process according to the first embodiment, processes in Steps S124 and S126 are added between Steps S110 and S112. FIGS. 1 and 3 to 6 are not modified in this embodiment. A flow of the process according to this embodiment will be described on the basis of a difference from the first embodiment.

(Step S124) When the output checker 12 detects an output command from the OS/application processor 10 (Step S110: Yes), the output checker 12 effects interruption and checks whether or not the output destination is a predefined storage device.

(Step S126) When the output destination is a predefined storage device (Step S124: Yes), the output checker 12 encodes the output data. The output checker 12 replaces the output data with the encoded data and then cancels the interruption. The encoded data is written to the predefined storage device via the BIOS 30.

According to the first embodiment, the permission for output and the instruction of clear output or encoded output are received from the user for every output. In contrast, according to this embodiment, with respect to storing data into the predefined storage device, the user's check is not performed, and the data is encoded without any condition. By storing data into a hard disc built in the computer or the like in this way, the burden on the user can be considerably alleviated.

It should be noted that the information-protection device according to the present invention can be embodied as a piece of hardware and also can be embodied as a piece of software of a computer. For example, when a program for causing the computer to execute functions of the output checker 12, the decoder 14, the unknown-data extractor 16, the unknown-data writer 18, the unknown-data reader 20, the encoder 24, and the input checker 28, which are shown in shown in FIG. 1, is created and the program is read into a memory of the computer for execution, the information-protection device can be realized.

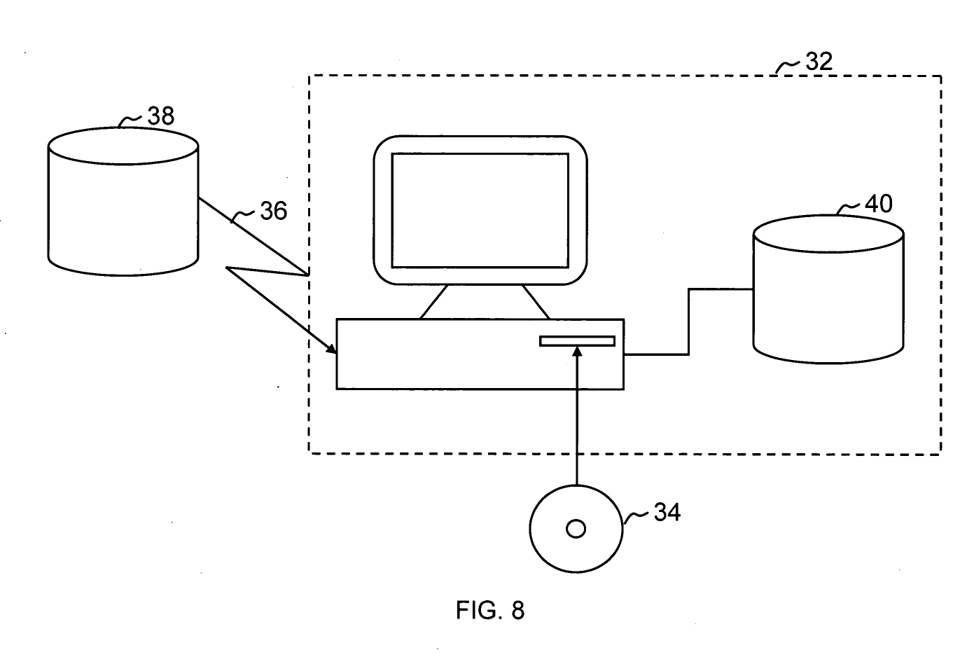

As shown in FIG. 8, the program for realizing the information-protection device according to the embodiments of the present invention may be stored not only in a transportable recording medium 34 such as, a CD-ROM, a CD-RW, a DVD-R, a DVD-RAM, a DVD-RW, or the like, or a flexible disc, but also in other storage device 38 provided to the end of a communication line 36 or a storage device or a recording medium 40 such as a hard disc of a computer system 32 or a RAM. At a time of program execution, the program is loaded and executed on a main memory.

It should be noted that each element of the information-protection device according to the present invention can be a single component and also can be a set of components. Furthermore, it should also be noted that a plurality of elements of the information-protection device according to the present invention can be a single component. Especially, in case that the information-protection device according to the present invention is embodied as a piece of software of a computer, a CPU (central processing unit) of the computer substantially serves as many elements of the information-protection device in accordance with the program for causing the computer to execute functions of the elements.

A realizing method of embodying the information-protection device according to the present invention as a piece of software of a computer will be described.

For example, activation of a personal computer is usually performed in the following procedure.

### 1. Power is turned on.

### 2. A BIOS recorded in a non-volatile memory is activated.

### 3. The BIOS loads MBR (Master Boot Record) recorded in the heading of a hard disc.

### 4. A boot loader included in the MBR is activated.

### 5. The boot loader selects an OS for activation.

This procedure is changed and a piece of software for realizing the information-protection device according to the present invention (hereinafter referred to as this software) is allowed to interrupt between the BIOS and the OS. The basic procedure for this is to record this software in a place where originally the MBR should be recorded and to read the MBR in place of the BIOS. For this reason, the MBR is moved to another place and an MBR loader for reading the MBR in place of the BIOS is created and recorded in the heading of the hard disc together with this software.

With this configuration, the personal computer is activated in the following procedure.

### 1. Power is turned on.

### 2. A BIOS recorded in a non-volatile memory is activated.

### 3. The BIOS loads this software and the MBR loader recorded in the heading of the hard disc.

### 4. The MBR loader is activated.

### 5. The MBR loader loads the MBR.

### 6. The boot loader included in the MBR is activated.

### 7. The boot loader selects an OS for activation.

As a result, this software stays in the personal computer and can interrupt between the BIOS and the OS.

What is claimed is:

1. An information-protection device for protecting information held in a computer, aid information-protection device being connected to the computer, said computer executing an existing function prescribed in an operating system or an application program, said information-protection device comprising:
a decoder for decoding data which is input for the existing function;
an unknown-data storage for storing data that cannot be processed in the existing function, as unknown data;
an encoder for encoding the unknown data;
an input checker for displaying a part of the encoded unknown data on a display device, and in response to a first instruction from a user, causing the computer to execute the existing function with the encoded unknown data as input; and
an output checker for displaying a part of output data from the existing function on the display device, and in response to a second instruction from the user, encoding the output data and outputting the encoded output data.

2. The information-protection device of claim 1, wherein:
said decoder decodes a first part of the unknown data and does not decode a second part of the unknown data;
said encoder encodes the first part of the unknown data and does not encode the second part of the unknown data; and
said input checker displays a part of the second part of the unknown data on the display device, and in response to the first instruction from the user, causes the computer to execute the existing function with the unknown data whose first part is encoded as input.

3. The information-protection device of claim 1, wherein
said output checker encodes the output data and outputs the encoded output data without the second instruction from the user, when a destination of the output is a predefined destination.

4. An information-protection system comprising a computer and an information-protection device connected to the computer, said computer executing an existing function prescribed in an operating system or an application program, said information-protection device protecting information held in the computer, said information-protection device comprising:
a decoder for decoding data which is input for the existing function;
an unknown-data storage for storing data that cannot be processed in the existing function, as unknown data;
an encoder for encoding the unknown data;
an input checker for displaying a part of the encoded unknown data on a display device, and in response to a first instruction from a user, causing the computer to execute the existing function with the encoded unknown data as input; and
an output checker for displaying a part of output data from the existing function on the display device, and in response to a second instruction from the user, encoding the output data and outputting the encoded output data.

5. The information-protection system of claim 4, wherein:
said decoder decodes a first part of the unknown data and does not decode a second part of the unknown data;
said encoder encodes the first part of the unknown data and does not encode the second part of the unknown data; and
said input checker displays a part of the second part of the unknown data on the display device, and in response to the first instruction from the user, causes the computer to execute the existing function with the unknown data whose first part is encoded as input.

6. The information-protection system of claim 4, wherein aid output checker encodes the output data and outputs the encoded output data without the second instruction from the user, when a destination of the output is a predefined destination.

7. An information-protection method for protecting information held in a computer, said computer executing an existing function prescribed in an operating system or an application program, said information-protection method comprising the steps of
decoding data which is input for the existing function;
storing data that cannot be processed in the existing function, as unknown data;
encoding the unknown data;
displaying a part of the encoded unknown data on a display device, and in response to a first instruction from a user, causing the computer to execute the existing function with the encoded unknown data as input; and
displaying a part of output data from the existing function on the display device, and in response to a second instruction from the user, encoding the output data and outputting the encoded output data.

8. The information-protection method of claim 7, wherein:
in said step of decoding data, a first part of the unknown data is decoded and a second part of the unknown data is not decoded;
in said step of encoding the unknown data, the first part of the unknown data is encoded and the second part of the unknown data is not encoded; and
in said step of displaying a part of the encoded unknown data, a part of the second part of the unknown data is displayed on the display device, and in response to the first instruction from the user, the computer is caused to execute the existing function with the unknown data whose first part is encoded as input.

9. The information-protection method of claim 7, wherein in said step of displaying a part of output data, the output data is encoded and output without the second instruction from the user, when a destination of the output is a predefined destination.

10. A program storage medium readable by a computer, said program storage medium storing a program of instructions for the computer to execute method steps of an information-protection method for protecting information held in the computer, said computer executing an existing function prescribed in an operating system or an application program, said information-protection method comprising the steps of:
decoding data which is input for the existing function;
storing data that cannot be processed in the existing function, as unknown data;
encoding the unknown data;
displaying a part of the encoded unknown data on a display device, and in response to a first instruction from a user, causing the computer to execute the existing function with the encoded unknown data as input; and
displaying a part of output data from the existing function on the display device, and in response to a second instruction from the user, encoding the output data and outputting the encoded output data.

11. The program storage medium of claim 10, wherein:
in said step of decoding data, a first part of the unknown data is decoded and a second part of the unknown data is not decoded;
in said step of encoding the unknown data, the first part of the unknown data is encoded and the second part of the unknown data is not encoded; and
in said step of displaying a part of the encoded unknown data, a part of the second part of the unknown data is displayed on the display device, and in response to the first instruction from the user, the computer is caused to execute the existing function with the unknown data whose first part is encoded as input.

12. The program storage medium of claim 10, wherein
in said step of displaying a part of output data, the output data is encoded and output without the second instruction from the user, when a destination of the output is a predefined destination.
